(19) United States
(12) Patent Application Publication
(10) Pub. No.: US 2022/0161610 A1
(43) Pub. Date: May 26, 2022

(54) PUNCTURE EMERGENCY SAFETY DEVICE FOR AUTOMOBILES

(71) Applicant: Lili Shan, Weifang City (CN)

(72) Inventor: Lili Shan, Weifang City (CN)

(21) Appl. No.: 16/953,379

(22) Filed: Nov. 20, 2020

(51) Int. Cl. B60C 17/04; B60B 19/00

(52) U.S. Cl. CPC B60C 17/041; B60B 19/00

(57) ABSTRACT

The invention discloses a puncture emergency safety device for automobiles comprises oppositely arranged first rubber member and second rubber member wherein one end of said first rubber member is connected with one end of the second rubber member via the first connector while the other end thereof is connected with the other end of the second rubber member via the second connector to enable the first rubber member and a second rubber member to enclose and form an annular structure. The invention, a puncture emergency safety device for automobiles, can save installation space and simplify fixing condition by virtue of oppositely arranged first rubber member and second rubber member; the invention has simple structure and easy to install, and at the same time, possesses function and advantages of rubber air spring and shock absorber which can exert function of bearing, buffering and shock absorbing.

### BACKGROUND OF THE INVENTION

### 1. Field of the Invention

The invention relates to the field of automobiles, specifically relating to a puncture emergency safety device for automobiles.

### 2. Description of the Related Art

When the vehicle has tire punctured in its driving process, the tires loses the supporting force to be separated from the hub, and loses the friction force with the ground, causing the wheel to be out of control. After installation of the puncture emergency safety device, the tire can be effectively prevented from being separated from the hub, and can continuously support the wheel along with the pressure-loss tire, obtaining good ground grabbing force to guarantee the safety and controllability of the vehicle, thus avoiding accident. While among the prior art, the puncture emergency safety device adopts metal plate plus nylon support framework mostly, which has disadvantages of heavy weight, easy rusty, high requirements for maintenance, high fault rate, and not suitable for overload load vehicle types.

### SUMMARY OF THE INVENTION

To solve above technical problems, the invention provides following technical plan: a puncture emergency safety device for automobiles comprising oppositely arranged first rubber member and second rubber member wherein one end of said first rubber member is connected with one end of the second rubber member via the first connector while the other end thereof is connected with the other end of the second rubber member via the second connector to enable the first rubber member and the second rubber member to enclose and form an annular structure. Said first rubber member and second rubber member have same structures, including the manganese steel band arranged innermost layer thereof, the nylon layer at the outside of and wrapping the manganese steel band and the rubber layer out of and wrapping the nylon layer, and a plurality of strip-shaped grooves on the oppositely arranged surfaces of said first rubber member and second rubber member.

As an improvement, said first connector comprises a first connecting plate and a second connecting plate which are respectively arranged on two sides of two end portions of the first rubber member and the second rubber member, a first U-shaped piece and a second U-shaped piece are respectively hinged between the first connecting plate and the second connecting plate wherein threaded holes are correspondingly formed in the middle portions of the first U-shaped piece and the second U-shaped piece with bolts arranged in the threaded holes in a matched mode, and said bolts sequentially penetrate through the first U-shaped piece and the second U-shaped piece to be connected and tightened with nut connecting piece.

As an improvement, the tightening torque for connecting and tightening said bolt and the nut connecting piece is at least 10 N*m.

As an improvement, said second connector comprises a third connecting plate and a fourth connecting plate which are respectively arranged on two sides of two end portions of the first rubber member and the second rubber member, and said third connecting plate and said fourth connecting plate are respectively hinged with two ends of the buckle cover through rivets.

As an improvement, said buckle cover comprises a buckle cover bottom plate and buckle cover side plates arranged on two sides of the buckle cover bottom plate, and the buckle cover side plates are arranged on the outer sides of the third connecting plate and the fourth connecting plate.

As an improvement, said buckle cover is an arc buckle cover, and a plurality of through holes are formed in the buckle cover bottom plate.

As an improvement, said through holes comprise strip-shaped through holes and round through holes.

As an improvement, said rivet and the buckle cover are both made of stainless steel materials.

After adopting following structure, the invention has following advantages: the invention, a puncture emergency safety device for automobiles, can save installation space and simplify fixing condition by virtue of oppositely arranged first rubber member and second rubber member; the invention has simple structure and easy to install, and at the same time, possesses function and advantages of rubber air spring and shock absorber which can exert function of bearing, buffering and shock absorbing.

### BRIEF DESCRIPTION OF THE DRAWINGS

FIG. 1 is the structural diagram of the puncture emergency safety device for automobiles in the invention.

FIG. 2 is the internal structural diagram of the first rubber member of the puncture emergency safety device for automobiles in the invention.

FIG. 3 is the structural diagram of the first connector of the puncture emergency safety device for automobiles in the invention.

FIG. 4 is the structural diagram of the second connector of the puncture emergency safety device for automobiles in the invention.

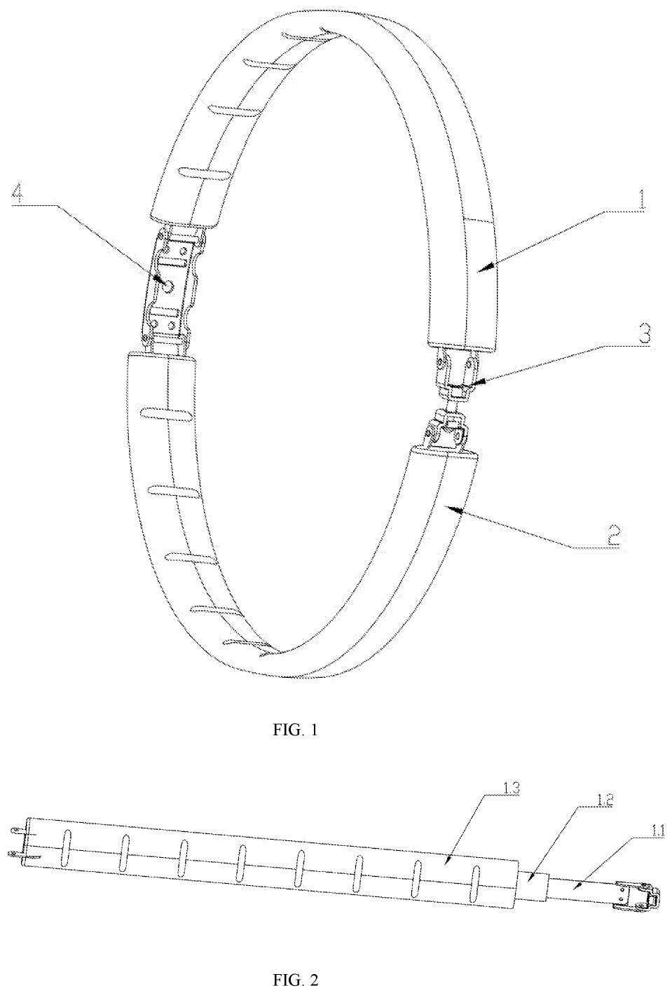

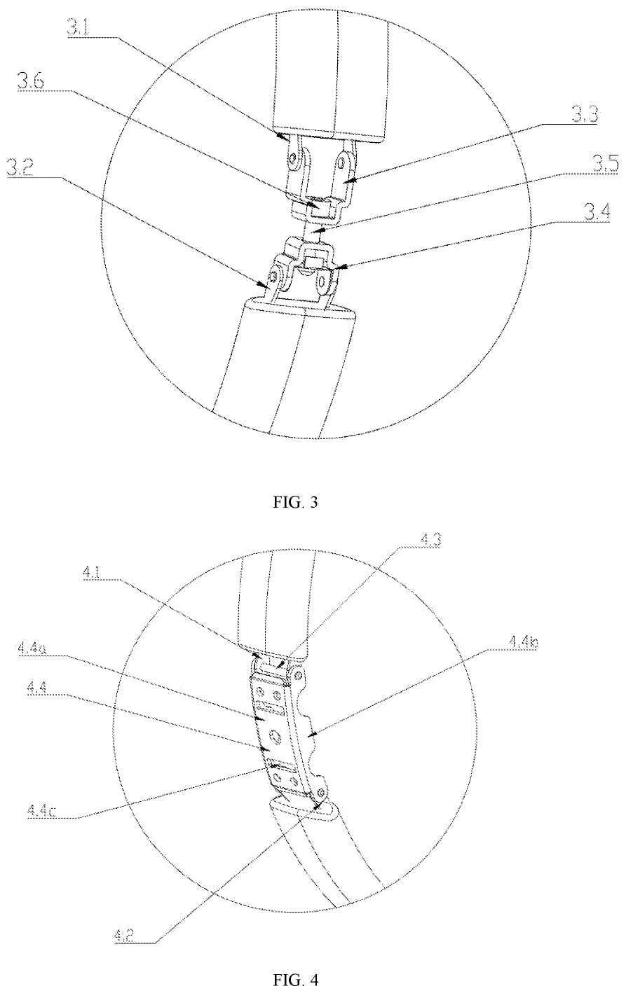

As shown in drawings, 1—first rubber member; 1.1—manganese steel band; 1.2—nylon layer, 1.3—rubber layer, 2—second rubber member, 3—first connector, 3.1—first connecting plate, 3.2—second connecting plate, 3.3—first U-shaped piece, 3.4—second U-shaped piece, 3.5—bolts, 3.6—nut connecting piece, 4—second connector, 4.1—third connecting plate, 4.2—fourth connecting plate, 4.3—rivet, 4.4—buckle cover, 4.4a—buckle cover bottom plate, 4.4b—buckle cover side plate, 4.4c—through holes.

### DETAILED DESCRIPTION OF THE PREFERRED EMBODIMENTS

With references to drawings, a puncture emergency safety device for automobiles comprises oppositely arranged first rubber member 1 and second rubber member 2 wherein one end of said first rubber member 1 is connected with one end of the second rubber member 2 via the first connector 3 while the other end thereof is connected with the other end of the second rubber member 2 via the second connector 4 to enable the first rubber member 1 and the second rubber member 2 to enclose and form an annular structure. Said first rubber member 1 and second rubber member 2 have same structures, including the manganese steel band 1.1 arranged innermost layer thereof, the nylon layer 1.2 at the outside of and wrapping the manganese steel band 1.1 and the rubber layer 1.3 out of and wrapping the nylon layer 1.2, which means that the rubber layer 1.3, the nylon layer 1.2 and the manganese steel band 1.1 are arranged in sequence from outside to inside, and a plurality of strip-shaped grooves on the oppositely arranged surfaces of said first rubber member 1 and second rubber member 2.

As a preferred solution for the embodiment, said first connector 3 comprises a first connecting plate 3.1 and a second connecting plate 3.2 which are respectively arranged on two sides of two end portions of the first rubber member 1 and the second rubber member 2, a first U-shaped piece 3.3 and a second U-shaped piece 3.4 are respectively hinged between the first connecting plate 3.1 and the second connecting plate 3.2 wherein threaded holes are correspondingly formed in the middle portions of the first U-shaped piece 3.3 and the second U-shaped piece 3.4 with bolts 3.5 arranged in the threaded holes in a matched mode, and said bolts 3.5 sequentially penetrate through the first U-shaped piece 3.3 and the second U-shaped piece 3.4 to be connected and tightened with the nut connecting piece 3.6.

As a preferred solution for the embodiment, the tightening torque for connecting and tightening said bolt 3.5 and the nut connecting piece 3.6 is at least 10 Nm.

As a preferred solution for the embodiment, said second connector 4 comprises a third connecting plate 4.1 and a fourth connecting plate 4.2 which are respectively arranged on two sides of two end portions of the first rubber member 1 and the second rubber member 2, and said third connecting plate 4.1 and said fourth connecting plate 4.2 are respectively hinged with two ends of the buckle cover 4.4 through rivets 4.3.

As a preferred solution for the embodiment, said buckle cover 4.4 comprises a buckle cover bottom plate 4.4a and buckle cover side plates 4.4b arranged on two sides of the buckle cover bottom plate 4.4a, and the buckle cover side plates 4.4b are arranged on the outer sides of the third connecting plate 4.1 and the fourth connecting plate 4.2.

As a preferred solution for the embodiment, said buckle cover 4.4 is an arc buckle cover, and a plurality of through holes 4.4c are formed in the buckle cover bottom plate 4.4a.

As a preferred solution for the embodiment, said through holes 4.4c comprise strip-shaped through holes and round through holes.

As a preferred solution for the embodiment, said rivet 4.3 and the buckle cover 4.4 are both made of stainless steel materials.

The invention constitutes complete first rubber member and second rubber member via the manganese steel band wrapping nylon layer and rubber layer and the first rubber member and second rubber member constitute a complete a puncture emergency safety device for automobiles via the second connector, wherein the nylon layer plays the effect of strengthening the breaking strength, and the rubber layer adopts high-strength and lightweight compounded rubber; the buckle cover and rivet adopt the punching press riveting form to connect together, and buckle cover and rivet all adopt stainless steel materials to avoid rusting and increase intensity; when in the process of using, the rubber members after connection is placed in the wheel rim groove, the first U-shaped piece and the second U-shaped piece are connected through connecting and tightening of the bolt in the first connector and the nut connecting piece, then the first rubber member and the second rubber member are made into an annular structure.

The invention abandons the foreign metal plate+nylon supporting framework, and adopts a fully upgraded lightweight compounded rubber supporting system, which solves the problems of high assembly and maintenance requirements, high failure rate, unsuitability for overloaded vehicles and the like which are puzzled in the industry for many years; the product disclosed in the invention has captured integration of lightweight, stainless steel buckle, manganese steel metal plate, high-strength nylon cord and rubber; it adopts compounded rubber all supporting framework and “wheel hub recess sealing technique” whose technical principle is to seal and support for the wheel hub recess so as to prevent the rear rim from touching the earth and skidding after tire punctured, effectively avoiding the overturn accident due to out of control of vehicle.

The invention and its embodiments have been described above, but the description is not limited thereto; only one embodiment of the invention is shown in the drawings, and the actual structure is not limited thereto. In general, it is to be understood by those skilled in the art that non-creative design of structural forms and embodiments that are similar to the technical solutions without departing from the spirit of the invention shall all fall within the protective scope of the invention.

1. A puncture emergency safety device for automobiles comprising oppositely arranged first rubber member and second rubber member wherein one end of said first rubber member is connected with one end of the second rubber member via the first connector while the other end thereof is connected with the other end of the second rubber member via the second connector to enable the first rubber member and the second rubber member to enclose and form an annular structure; said first rubber member and second rubber member have same structures, including the manganese steel band arranged innermost layer thereof, the nylon layer at the outside of and wrapping the manganese steel band and the rubber layer out of and wrapping the nylon layer, and a plurality of strip-shaped grooves on the oppositely arranged surfaces of said first rubber member and second rubber member.

2. The puncture emergency safety device for automobiles of claim 1 wherein said first connector comprises a first connecting plate and a second connecting plate which are respectively arranged on two sides of two end portions of the first rubber member and the second rubber member, a first U-shaped piece and a second U-shaped piece are respectively hinged between the first connecting plate and the second connecting plate wherein threaded holes are correspondingly formed in the middle portions of the first U-shaped piece and the second U-shaped piece with bolts arranged in the threaded holes in a matched mode, and said bolts sequentially penetrate through the first U-shaped piece and the second U-shaped piece to be connected and tightened with nut connecting piece.

3. The puncture emergency safety device for automobiles of claim 2 wherein the tightening torque for connecting and tightening said bolt and the nut connecting piece is at least 10 N*m.

4. The puncture emergency safety device for automobiles of claim 1 wherein said second connector comprises a third connecting plate and a fourth connecting plate which are respectively arranged on two sides of two end portions of the first rubber member and the second rubber member, and said third connecting plate and said fourth connecting plate are respectively hinged with two ends of the buckle cover through rivets.

5. The puncture emergency safety device for automobiles of claim 4 wherein said buckle cover comprises a buckle cover bottom plate and buckle cover side plates arranged on two sides of the buckle cover bottom plate, and the buckle cover side plates are arranged on the outer sides of the third connecting plate and the fourth connecting plate.

6. The puncture emergency safety device for automobiles of claim 4 wherein said buckle cover is an arc buckle cover, and a plurality of through holes are formed in the buckle cover bottom plate.

7. The puncture emergency safety device for automobiles of claim 6 wherein said through holes comprise strip-shaped through holes and round through holes.

8. The puncture emergency safety device for automobiles of claim 1 wherein said rivet and the buckle cover are both made of stainless steel materials.
